(19) United States
(12) Patent Application Publication
(10) Pub. No.: US 2018/0024717 A1
(43) Pub. Date: Jan. 25, 2018

(54) PLAYBACK OF MEDIA CONTENT INLINE WITHIN A SCROLLABLE MIXED MULTIMEDIA DISPLAY BACKGROUND

(71) Applicant: Google Inc., Mountain View, CA (US)

(72) Inventors: Tae Wan An, Cambridge, MA (US); Cassandra Doll, Mountain View, CA (US); Haoxuan Cai, Cambridge, MA (US); Maurice Shore, Carlisle, MA (US)

(21) Appl. No.: 15/659,115

(22) Filed: Jul. 25, 2017

Related U.S. Application Data
(60) Provisional application No. 62/366,393, filed on Jul. 25, 2016.

(51) Int. Cl. G06F 3/0485; G06F 3/0484; G06F 17/21

(52) U.S. Cl. CPC G06F 3/0485; G06F 17/212; G06F 3/04845

(57) ABSTRACT

A method of playing back media content inline within a scrollable mixed multimedia display background is provided. The mixed multimedia content may be displayed in a scrollable container, and thumbnails of playable media items may be displayed in the mixed multimedia content. In response to detecting a user interaction that can be regarded as an intent to start consuming the media item, a media item thumbnail is visually replaced with a player user interface that plays back the media item. When the scrollable container is scrolled, the player is repositioned in tandem with the scrolling motion, so the player appears inline with the rest of the mixed multimedia content. Then the player is moved to a designated position on the screen to allow uninterrupted media consumption when the scrollable container is scrolled to an extent where the position of the player would be deemed unsuitable for media consumption.

### CROSS-REFERENCE TO RELATED APPLICATIONS

This application claims the benefit of U.S. Provisional Application Ser. No. 62/366,393, filed Jul. 25, 2016, the disclosure of which is incorporated by reference in its entirety.

### BACKGROUND

A multimedia document (e.g., a news article that includes a video) that is too large to be displayed as a whole in a container, such as a display screen, typically requires a scrolling container (e.g. a browser window, or a scrollable application user interface “(“app UI”)). In typical systems, video content of the multimedia document is first depicted as a thumbnail, and, based on user interaction, the video plays either inline or in a new environment, such as in a separate application, a new browser window, a pop-up window, or the like.

In typical systems, if the video plays inline and the user continues to consume the rest of the multimedia document by scrolling, the inline video will be scrolled off the display screen. That is, the scrolling causes the consumption of the video to be interrupted. If video plays in a new environment, then the user is forced to choose between consuming just the video, or just the document.

### BRIEF SUMMARY

Implementations of the disclosed subject matter provide a method that includes displaying, on a display coupled to an electronic device, mixed multimedia content in a scrollable container. The method includes displaying, on the display coupled to the electronic device, thumbnails of playable media items in the mixed multimedia content. At least one media item thumbnail of the thumbnails of playable media items is replaced with a media player user interface that plays back a media item of the playable media items based on detecting a user interaction, where the user interaction is determined by the electronic device as an intention to start consuming the media item. The method includes repositioning, on the display coupled to the electronic device, the media player when a scrollable container is scrolled, in tandem with a scrolling motion, so the media player appears inlined with the mixed multimedia content. The media player may be moved to a designated position on the display to allow uninterrupted consumption of the mixed multimedia content, including the media to be played back. This may occur when the scrollable container is scrolled to an extent where it is determined, at the electronic device, that the position of the media player based on the scrolling interrupts the consumption of the mixed media content.

Implementations of the disclosed subject matter provide a system including a display device and an electronic device communicatively coupled to the display. The electronic device controls the display device to display mixed multimedia content in a scrollable container, to control the display device to display thumbnails of playable media items in the mixed multimedia content. The electronic device controls to visually replace of at least one media item thumbnail of the thumbnails of playable media items with a media player user interface that plays back a media item of the playable media items based on detecting a user interaction, where the user interaction is determined by the electronic device as an intention to start consuming the media item. The electronic device controls the display device to reposition the media player when a scrollable container is scrolled, in tandem with a scrolling motion, so the media player appears inlined with the mixed multimedia content. The electronic device controls the display device to move the media player to a designated position on the display device to allow uninterrupted consumption of the mixed multimedia content, including the media to be played back, when the scrollable container is scrolled to an extent where it is determined, at the electronic device, that the position of the media player based on the scrolling interrupts the consumption of the mixed media content.

According to an implementation of the disclosed subject matter, means for playback of media content inline are provided for displaying, on a display coupled to an electronic device, mixed multimedia content in a scrollable container. Means for displaying, on the display coupled to the electronic device, thumbnails of playable media items in the mixed multimedia content are included. At least one media item thumbnail of the thumbnails of playable media items is replaced with a media player user interface that plays back a media item of the playable media items based on detecting a user interaction, where the user interaction is determined by the electronic device as an intention to start consuming the media item. Means for repositioning, on the display coupled to the electronic device, the media player when a scrollable container is scrolled, in tandem with a scrolling motion, so the media player appears inlined with the mixed multimedia content are included. The media player may be moved to a designated position on the display to allow uninterrupted consumption of the mixed multimedia content, including the media to be played back, when the scrollable container is scrolled to an extent where it is determined, at the electronic device, that the position of the media player based on the scrolling interrupts the consumption of the mixed media content.

Additional features, advantages, and implementations of the disclosed subject matter may be set forth or apparent from consideration of the following detailed description, drawings, and claims. Moreover, it is to be understood that both the foregoing summary and the following detailed description are illustrative and are intended to provide further explanation without limiting the scope of the claims.

### BRIEF DESCRIPTION OF THE DRAWINGS

The accompanying drawings, which are included to provide a further understanding of the disclosed subject matter, are incorporated in and constitute a part of this specification. The drawings also illustrate implementations of the disclosed subject matter and together with the detailed description serve to explain the principles of implementations of the disclosed subject matter. No attempt is made to show structural details in more detail than may be necessary for a fundamental understanding of the disclosed subject matter and various ways in which it may be practiced.

FIG. 1 shows an example of a computing device according to an implementation of the disclosed subject matter.

FIG. 2 shows an example of a network configuration according to an implementation of the disclosed subject matter.

FIG. 3 shows an example of a system configuration according to an implementation of the disclosed subject matter.

FIGS. 4A-4H show examples of user interfaces displayed on a display device of an electronic device according to implementations of the disclosed subject matter.

FIG. 5 shows an example method according to an implementation of the disclosed subject matter.

### DETAILED DESCRIPTION

Implementations of the disclosed subject matter provide systems and methods of allowing a user to simultaneously consume different portions of multimedia content, such as text and video. That is, implementations of the disclosed subject matter provide systems and methods that allow a user to view text without having inline video scrolled off screen, and that avoid interruption of the consumption of the video when viewing other portions of the multimedia content, such as text.

The presently-disclosed subject matter relates to methods and apparatus for playing back media content inline within a scrollable mixed multimedia display background. In some implementations, mixed multimedia content may be displayed in a scrollable container, and thumbnails of playable media items, such as music albums, music playlists, videos, movies, photos, images, slideshows, text, articles, or books, may be displayed in the mixed multimedia content. In some implementations, a media item thumbnail may be visually replaced with a media player that includes a user interface (UI) that plays back the media item in response to detection of a user interaction that can be perceived as an intention to start consuming the media item. The media item may be one or more of various types of media content, such as music albums, music playlists, videos, movies, photos, images, slideshows, articles, or books. In some implementations, the media player may be repositioned when the scrollable container is scrolled in tandem with the scrolling motion, such that the player appears inline with the rest of the mixed multimedia content.

In some implementations, the media player may be moved to a designated position on a display to allow uninterrupted media consumption, when the scrollable container is scrolled to an extent where the position of the player would be deemed unsuitable for media consumption. That is, the systems and methods of the disclosed subject matter determine when a user command, such as a scroll operation, may otherwise move at least a portion of the media player off the display or obstruct the view of the media player, and dynamically adjust the position of the media player so as to provide a desirable multimedia playback experience for the user. In some implementations, media consumption may be regarded as suitable when the media item thumbnail is fully displayed on a display device and not obstructed by other UI components or partially off of the display due to the scrollable container and/or additional scrollable containers.

In some implementations, the scrollable container may be scrollable in one direction and contain additional containers. The additional containers (e.g., sub-containers or child containers) may be scrollable in an orthogonal direction to the scrollable container (e.g., the main scrollable container that may include the sub-containers or child containers). For example, the scrollable container may be scrollable in a horizontal direction, and the additional containers within that scrollable container may be scrollable in a vertical direction. In another example, the scrollable container may be scrollable in a vertical direction, and the additional containers within that scrollable container may be scrollable in a horizontal direction. In other implementations, the scrollable container and/or the additional containers may be an omni-directionally scrollable container itself, that is, scrollable in any direction.

In some implementations, the scrollable container and any applicable child container may be automatically scrolled, in response to the user interaction to start media consumption, in order to position the media item thumbnail in a screen position that is suitable for continued media consumption.

The systems and methods of playing back media content inline according to implementations of the disclosed subject matter may be applicable to various types of content in various media environments. For example, the implementations of the disclosed subject matter may be applicable to the playing of video content on a web page, where the video may be played inline and then scrolled off the display in response to a scroll operation received from a user's electronic device. In another example, the systems and methods of the disclosed subject matter may be applicable to various social media applications to allow preview of inline video content in the media stream. For example, the video content may be played silently (i.e., without accompanying audio content) and inline when scrolled into view on the display of the user's electronic device, and as soon as it is scrolled off the display, the preview may stop. The systems and methods according to implementations of the disclosed subject matter may also be applicable to various display arrangements. For example, video content may be played in a full-screen arrangement on a display of a user's electronic device, or may open in a separate application, while the consumption of any media content previously displayed on the display of the user's electronic device is stopped.

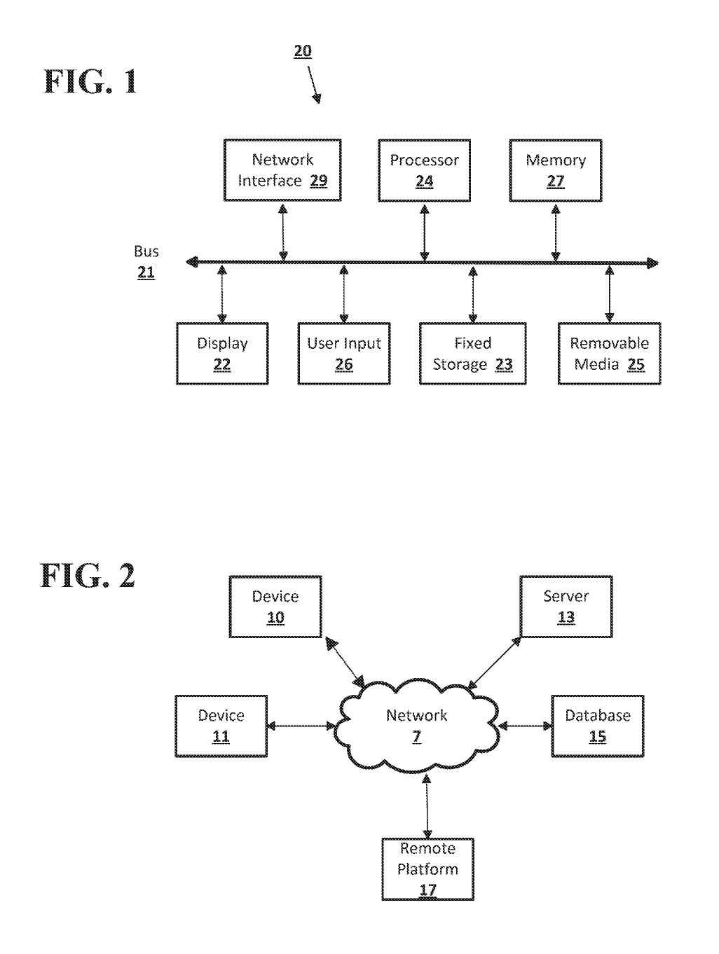

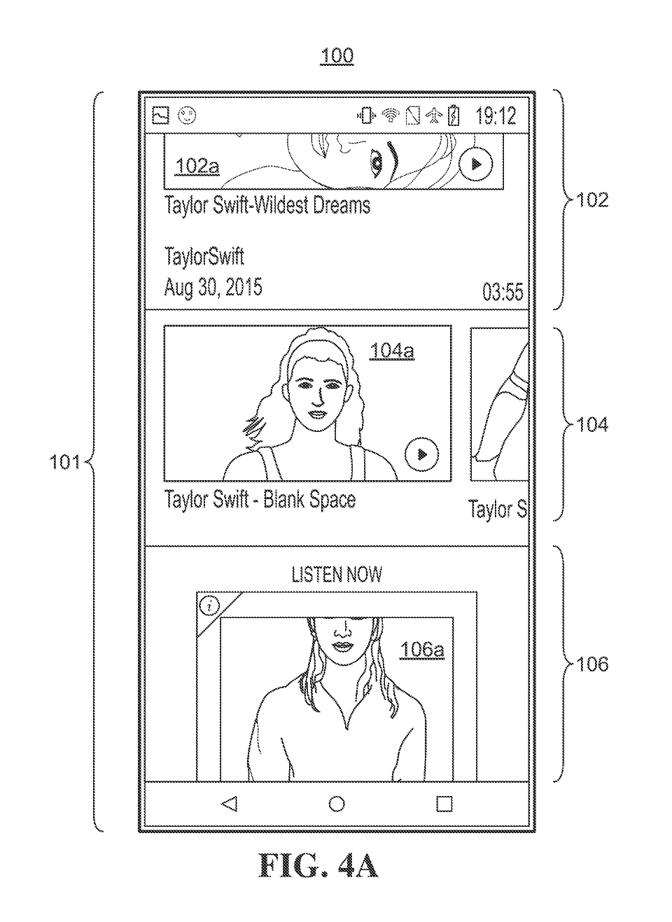

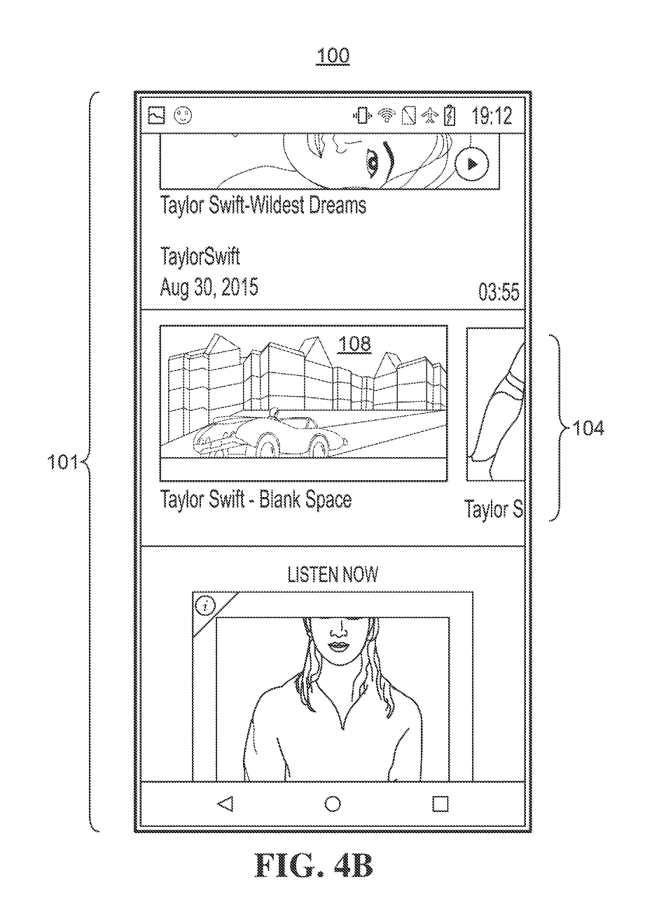

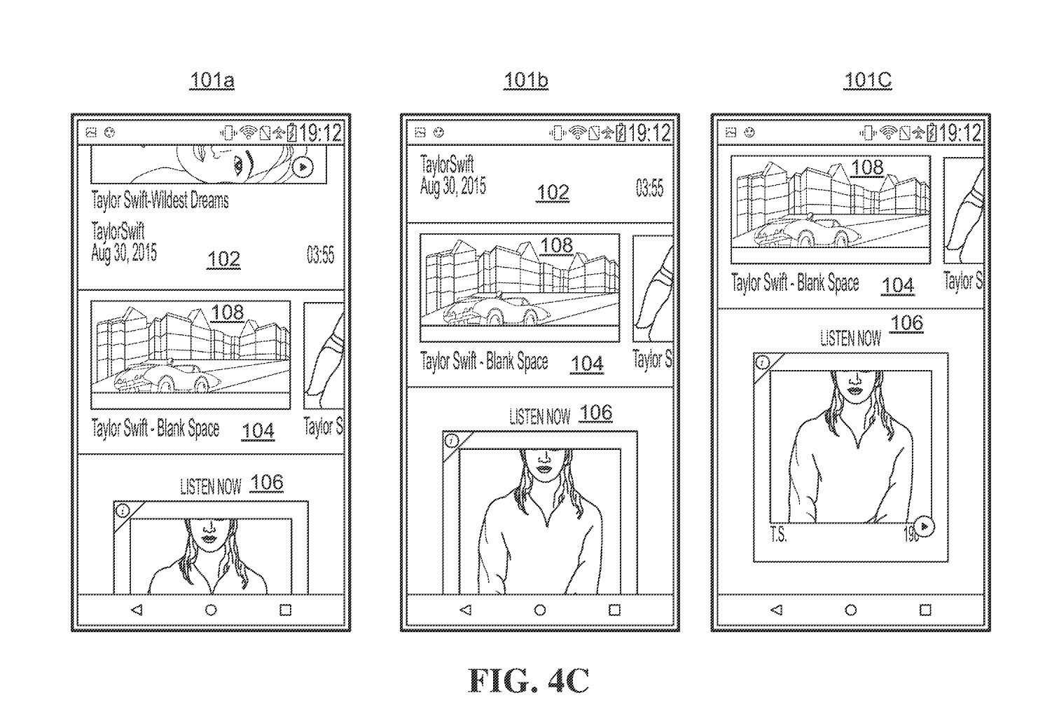

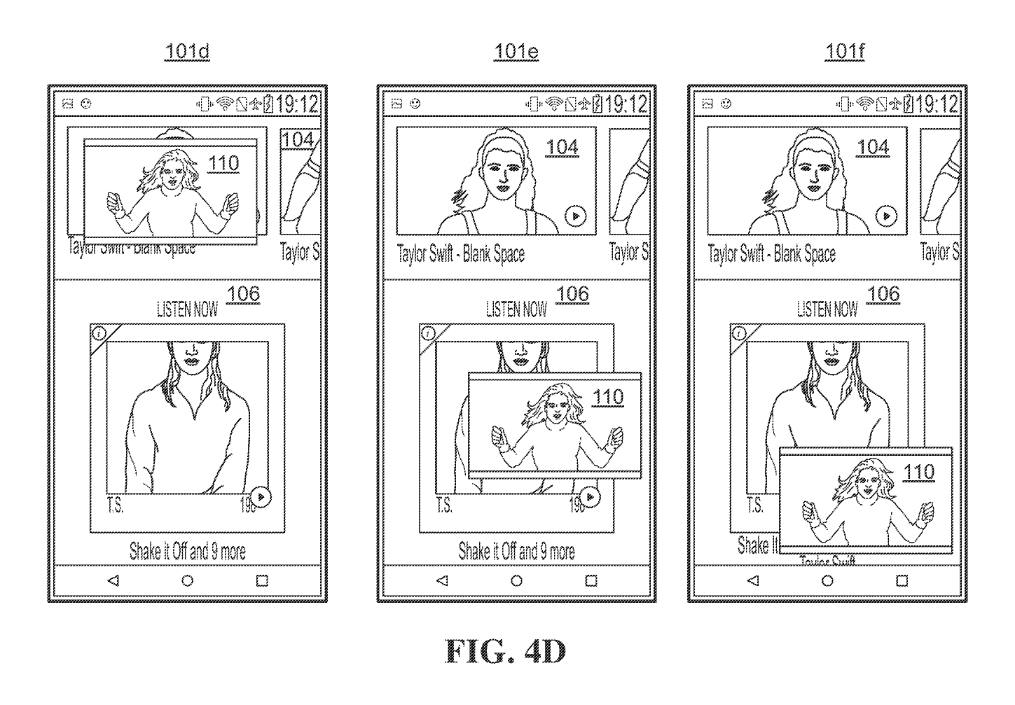

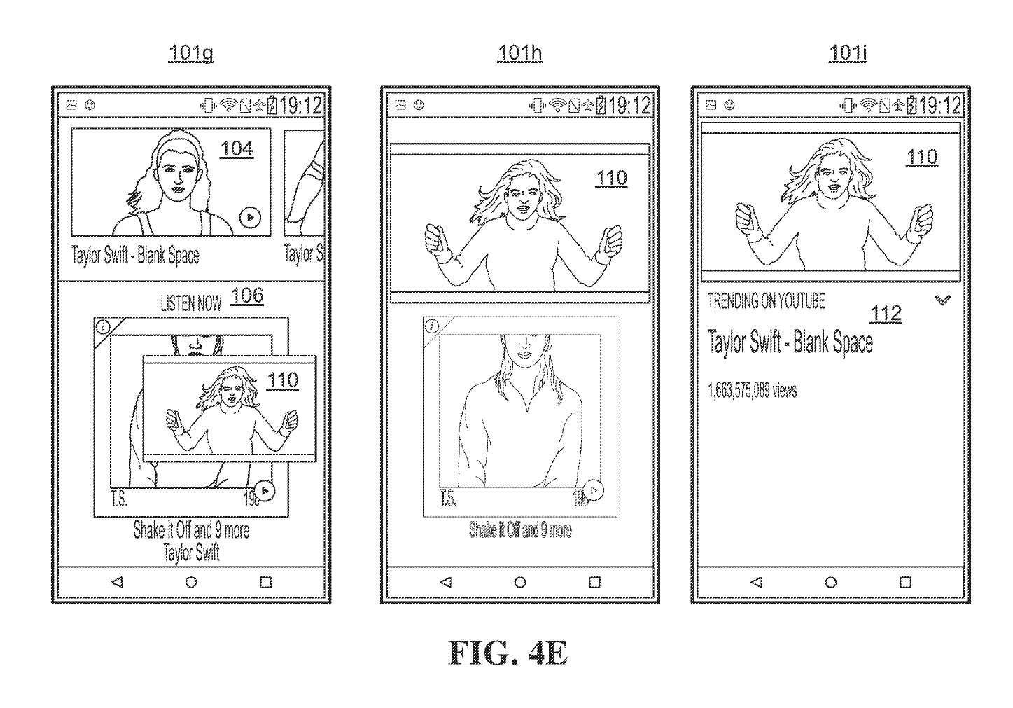

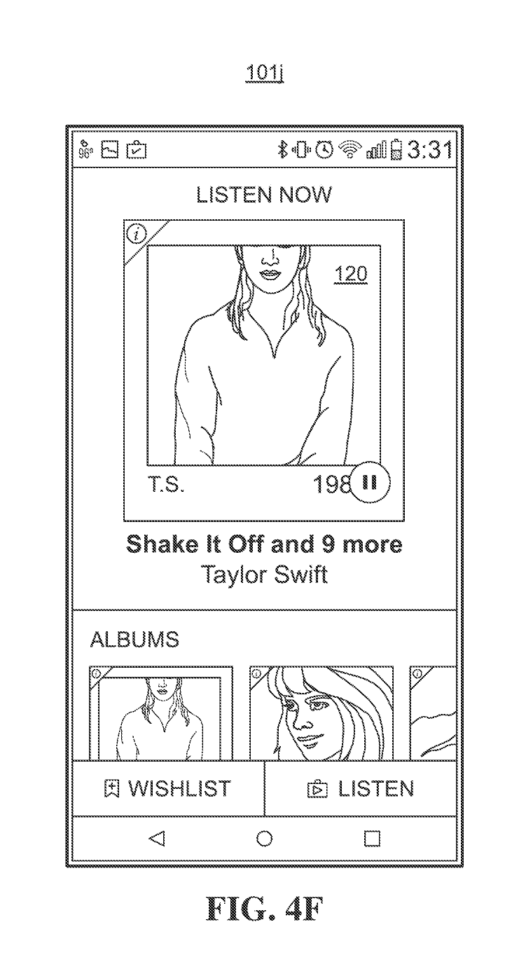

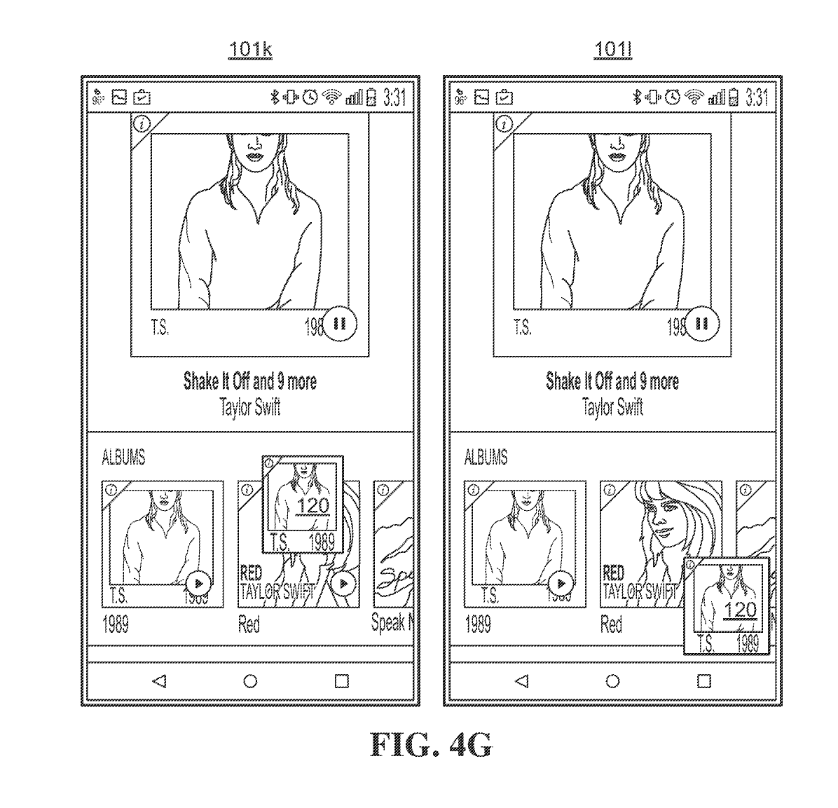

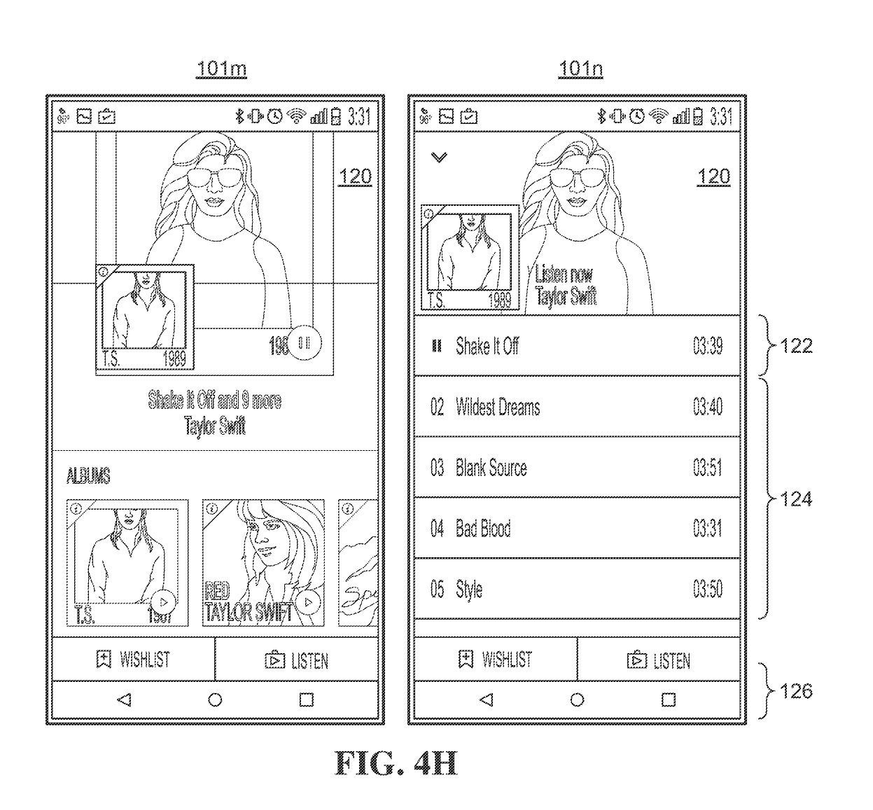

FIGS. 4A-4H show examples of user interfaces displayed on a display device of an electronic device, such as the display 22 of the computing device 20 discussed below in connection with FIG. 1, according to implementations of the disclosed subject matter. The example displays shown in FIGS. 4A-4H may be adjusted by a processor 24 of the computing device 20, based on, for example, input received from a user via a user input interface 26.

FIG. 4A shows an example of a display 100 displayed on display 22 of a computing device 20 (shown in FIG. 1) having a scrollable container 100 that includes mixed media content in separate containers 102, 104 and 106 (i.e., child containers). The scrollable container 100 may be scrolled, via a received input from user input interface 26 of the computing device 20 of FIG. 1, in a vertical direction to display additional mixed media content. The scrollable container 100, may be scrollable in other directions, such as a horizontal direction, or may be scrollable omni-directionally.

In some implementations, one or more of the separate containers 102, 104, 106 shown in FIG. 4A may be scrollable in the horizontal direction via a received input to the computing device 20. As shown in FIG. 4A, the container 104, which includes a thumbnail 104a for a playable media content item, may be horizontally scrollable to display additional media content. That is, the container 104 may be scrollable to show additional thumbnails representing playable media content.

In the example shown in FIG. 4A, containers 102 and 104 include thumbnails 102a and 104a, respectively, for videos, which when selected via a received input by the user input interface 26, may be played back on a media player stored on the computing device 20. Container 106 may include a thumbnail 106a for music and/or audio, which, when selected, may be played back on the media player. The container 100 is not limited to the containers 102, 104, 106 having videos and music, and may include separate containers having audio, songs, video, text, articles, music playlists, music albums, pictures, photos, and the like. That is, the containers 102, 104, and 106 may include thumbnails 102a, 104a, and 106a for playable media content items, respectively, which may be selected via a command received via the user input interface 26 of the computing device 20.

FIG. 4B shows the display 101 that may be displayed on display 22 of the computing device 20 shown in FIG. 1, where the video content of container 104 may be played back with the media player 108 of the computing device 20. In some implementations, playback may be started automatically by the computing device 20, or may be initiated by a user command received via the user input interface 26 to begin playback of the video or other media item. In some implementations, the playback of the media item (e.g., video) may begin when a thumbnail, such as thumbnail 104a of container 104 shown in FIG. 4A, is selected by a user command received by the user input interface 26.

FIG. 4C shows a sequence of displays 101a, 101b, and 101c of the media player 108 moving in tandem as the rest of the displayed content as the scrollable container 100 scrolls. As shown in FIG. 4C, as a vertical scroll operation is performed by the computing device 20, the displays 101a, 101b, 101c may be displayed on the display 22 of the computing device 20, and the container 104 that includes the video being played back by the media player 108 remains visible in each of the displays 101a, 101b, and 101c.

In display 101a of FIG. 4C, the media content of containers 102 and 106 may be partially visible. As the vertical scroll operation continues, as shown in displays 101b and 101c, a greater portion of media content in container 106 is visible in the display 101b, and a reduced portion of the media content in container 102 is visible in the display 101b. In the display 101c of FIG. 4C, the continued vertical scroll operation received by the user input interface 26 may be such that the media content of the container 102 is no longer displayed. The video playback in container 104 may continue with the media player 108, and the media content of the container 106 may be fully visible on the display 22 of the computing device 20. That is, the media player 108 may continue to be fully displayed in the container 104 of the displays 101a, 101b, and 101c as a vertical scrolling operation is performed based on a received used input via the user input interface 26.

FIG. 4D shows a sequence of displays 101d, 101e, and 101f, where the media player 110 is shown moving to a designated position in the respective displays 101d, 101e, and 101f during a scroll operation. In the example displays 101d, 101e, and 101f, the media player 110 is playing back a video. In other implementations, a media player may play back other types of media, such as audio, images, pictures, text, or the like. As shown in the sequence of displays 101d, 101e, and 101f, instead of continuing to follow the vertical scroll movement when the media player 110 may be scrolled off the display in response to a scroll operation received by the user input interface 26, the processor 24 may adjust the positioning of the media player 110 in a diagonal direction from the top left corner of display 101d to the bottom right corner of display 101f. The processor 24 of the computer device 20 may control the movement of the media player 110 within the displays 101d, 101e, and 101f. That is, the processor 24 may control the positioning of the media player 110 so that it remains fully visible when a scrolling operation is received by the user input interface 26.

FIG. 4E shows a sequence of displays 101g, 101h, and 101i in which the media player 110 is displayed at a designated position on the display 22 of the computing device 20, and the size of the media player 110 may be increased by the processor 20 to increase the media playback experience for the user. That is, the processor 24 of the computing device 20 may adjust the size and location of the media player 110, such that the media player 110 may increase in size in displays 101g, 101h, and 101i, respectively. In some implementations of the disclosed subject matter, the inlined media player 110 may be increased in size and/or maximized in one or both dimensions on the display 22 of the computing device 20. The computing device 20 may increase and/or maximize the dimensions of the media player 110 automatically, or in response to a user command received via the user input interface 26.

In some implementations of the disclosed subject matter, the inlined media player 110 may not occupy the entire display or an entire dimension of the display. For example, as shown in display 101h of FIG. 4E, the dimensional size of the media player 110 may be increased by the processor 24 of the computing device 20, but the media player 110 may not fill the entirety of the display 101h. In another example, as shown in display 101i of FIG. 4E, the dimensional size of the media player 110 may be increased, and additional media content information 112 may be displayed that may relate to and/or provide description information for the media being played by the media player 110. The additional media content information 112 may provide media content information that may be related to and/or different from the media being played by the media player 110. The additional media content information 112 may be provided, for example, by server 13, database 15, and or remote platform 17 to the computing device 20 via the network 7 shown in FIG. 2.

FIG. 4F shows a display 101j that includes a media player 120 that is a music player inlined at a thumbnail position (e.g., thumbnail 104a shown in FIGS. 4A). In some implementations, the processor 24 of the computing device 20 may inline the media player 120 in the display 101j by replacing the thumbnail of media content with the media player 120. In the display 101j, the media player 120 may appear to be similar to a thumbnail of media content, such as an album cover for music. In some implementations of the disclosed subject matter, a play time indicator, music album cover art, and/or a control button (e.g., a play button, a forward button a reverse button, and/or a pause button) may be provided at predetermined designated locations on the display 101j. The control button may be selectable via the user input interface 26 of the computing device 20.

FIG. 4G shows a sequence of displays 101k and 101l showing decreased screen area and minimization of the media player 120 that is a music player when the scroll position would otherwise place the media player at least partially off of the display when a scroll command is received by the user input 26 of the computing device 120. The processor 24 may determine that the received input via the user input interface 26 (e.g., for a scroll operation) may place the media player 120 at least partially off of a display, and the processor 20 may adjust the size and/or position of the media player so that it remains fully displayed. For example, the sequence of displays 101k and 101l show the media player 120 being minimized and adjusted by the processor 24 so as to be moving downward and to the bottom right hand corner of the displays 101k, 101l when a scrolling operation is received.

FIG. 4H shows displays 101m and 101n where the media player 120 is maximized in the horizontal dimension to increase the media experience for a user. The media player 120 may be maximized automatically by the processor 24 of the computing device 20, or may be maximized when a user command is received by the user input interface 26 of the computing device 20. Area 122 of display 101n shows the audio track that is currently being played and a pause button to pause the current play. Although a pause button is shown, other controls, such as play, stop forward, reverse, or the like may be displayed as part of area 122 and/or media player 120. Area 124 of display 101n show upcoming audio tracks to be played in sequence. Although the media player 120 of displays 101m and 101n shows a media player 120 that is a music player, the media player 120 may play videos, display text, display photos or images, or the like. Upon receiving a command from a user via the user input interface 26 of the computing device 20, such as selection of an interface item in area 126 at the bottom interface of FIG. 4H, the media being played by the media player 120 may return to its previous inline position, such as those shown in FIGS. 4A-4F and described above.

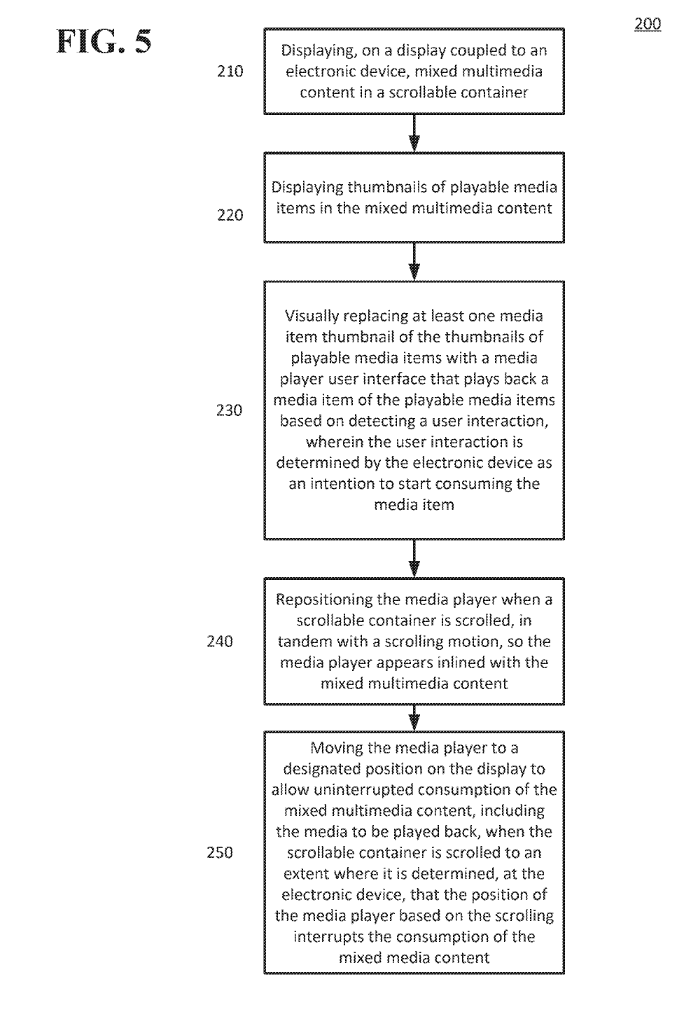

FIG. 5 shows a method 200 of playback of media content inline within a scrollable mixed multimedia display according to implementations of the disclosed subject matter. At operation 210, mixed multimedia content may be displayed on a display 22 of a computing device 20 in a scrollable container. For example, as shown in FIG. 4A and discussed above, a display 101 may have a container 100 having additional containers 102, 104, and 106, each with playable media items, shown as thumbnails 102a, 104a, and 106a, respectively. At operation 220 of FIG. 5, thumbnails may be displayed on the display 22 of playable media items in the mixed multimedia content. For example, the containers 102, 104, and 106 may include thumbnails of media that may be played by a media player that is operated by computing device 20. The thumbnails of the playable media may represent text, audio, a music playlist, a music album, a video, an image, a photo, a photo album, or the like.

At operation 230 of FIG. 5, at least one media item thumbnail of the thumbnails of playable media items may be replaced with a media player user interface that plays back a media item based on detecting a user interaction. For example, thumbnail 104a shown in FIG. 4A may be replaced by the processor 24 with the media player 108, which plays back the media item associated with the thumbnail 104a in the container 104, based on a user selection via the user input interface 26 of the computing device 20.

At operation 240 of FIG. 5, the processor 24 of the computing device 20 may reposition the media player when a scrollable container is scrolled, in tandem with a scrolling motion, so the media player appears inlined with the mixed multimedia content. For example, as shown in FIG. 4C and described above, the media player 108 may be inlined with the mixed media content of container 104, amongst the containers 102 and 106 having media content, as the displays (e.g., as shown in displays 101a,101b, and 101c) are scrolled.

At operation 250, the processor 24 of the computing device 20 may move the media player to a designated position on the display 22 to allow uninterrupted consumption of the mixed multimedia content, including the media to be played back. For example, the media player 108, shown in FIG. 4C, may be moved when a scroll operation occurs, so that the video being played by the media player 108 may be uninterrupted. In another example, the media player 110, as shown in FIG. 4D, may be moved in the display 22 when the processor 24 determines that a scrolling operation may otherwise move the media player 110 off of the display. That is, at operation 250, the processor 24 may move a media player in a display when it determines that, in response to a user scroll operation received by the user input interface 26, a scrollable container (e.g., container 104) is scrolled to an extent where it is determined that the position of the media player would be moved so as to interrupt the consumption of the media content.

In some implementations, the method 200 may include scrolling the scrollable container in one direction that may be a vertical direction, a horizontal direction, and a diagonal direction. For example, the containers 102, 104 and/or 106 may be scrolled in a vertical direction (e.g., as shown in FIG. 4C). The container 104, shown in FIG. 4A, may be scrolled in a horizontal direction to access thumbnails (e.g., other thumbnails beside the thumbnail 104a displayed in display 101). In some implementations, the method 200 may include scrolling the containers (e.g. containers 102, 104, 106) in an orthogonal direction to the horizontal or vertical direction. For example, container 104 may be scrolled in a horizontal direction so as to display additional thumbnails, which is orthogonal to the vertical direction that containers 102, 104, and 106 of container 100 may be scrolled (as shown in FIG. 4C). In some implementations, the containers 102, 104, and/or 106 may be moved omni-directionally on a display 22 in response to a received scroll operation by a user input interface 26.

The method 200 may include automatically scrolling the container (e.g., container 100 shown in FIG. 4A) and/or one or more additional containers (such as containers 102, 104, and/or 106), based on the computing device 20 responding to the detected user interaction at user input interface 26 to start consumption of the media item. The processor 24 of the computing device 20 may position the thumbnail (e.g., thumbnail 104a) of the media item to be played by a media player in a position on the display suitable for the consumption of the media item. Suitable viewing of the media item may include where the media item is fully shown on the display, and is not partially obstructed and/or partially displayed. For example, in FIGS. 4C and 4D, the processor 24 may position the media player 108, 110 in a position on the display (e.g., displays 101a, 101b, and/or 101c for media player 108, and displays 101d, 101e, and/or 101f for media player 110) that is suitable for the user to view the media item. That is, in some implementations, the method 200 may include determining a suitability for consumption of the media item based on whether the media item thumbnail (e.g., thumbnail 104a) of the media to be played in the media player is displayed fully on the display, and is not obstructed by other user interface components or displayed partially due to the scrollable container (e.g., container 104) or additional scrollable containers (e.g., containers 102 and/or 106).

In some implementations of the disclosed subject matter, the method 200 may include adjusting displayed size of the media player in response to a user command to expand the media consumption environment on the display. For example, displays 101h and 101i show the displayed size of the media player 110 have been increased by the processor 24 of the computing device 20, so as to improve the user experience in viewing the media content played by the media player, and to provide additional information (e.g., information 112, as shown in display 101i of FIG. 4E). In another example, as shown in FIG. 4F, the displayed size of the media player 120 in display 101j that plays audio tracks may be increased. Similarly, display 101n of FIG. 4H shows the audio track media player 120 with an increased display to improve the user experience with the media player (e.g., by displaying the played audio track and control buttons for controlling the playback of the audio track in area 122, and additional audio tracks to be sequentially played in area 124).

In some implementations of the method 200 in the disclosed subject matter, the processor 24 of the computing device 20 may reduce a displayed size of the media player in response to a user command to reduce the media consumption environment on the display. For example, as shown in FIG. 4G, the media player 120 may be minimized by the processor 24 when a user scroll operation would otherwise position the media player 120 off of the display (of the display 101k and/or display 101l).

The method 200 may include, in some implementations, moving the media player to a designated portion of the display in response to a received user command. For example, as shown in FIG. 4D, a command (e.g., a scroll operation) may be received by the user input interface 26 of the computing device 20, and the processor 24 may move the media player 110 to a designated portion of the display. That is, media player 110 may be moved to designated portions of displays 101d, 101e, and 101f of FIG. 4D, based on a received scroll operation command from a user via the user input interface 26.

Implementations of the presently disclosed subject matter may be implemented in and used with a variety of component and network architectures. FIG. 1 is an example of a computing device 20 suitable for implementing implementations of the presently disclosed subject matter. The device 20 may be, for example, a user device such as a desktop or laptop computer, or a mobile computing device such as a smart phone, tablet, or the like. In some implementations, the device 20 may be a computer or an application store server that determines usage parameters based on histories of application usage on user devices and assigns weights to user reviews based on the usage parameters. The device 20 may include a bus 21 which interconnects major components of the computer 20, such as a central processor 24, a memory 27 such as Random Access Memory (RAM), Read Only Memory (ROM), flash RAM, or the like, a user display 22 such as a display screen, a user input interface 26, which may include one or more controllers and associated user input devices such as a keyboard, mouse, touch screen, and the like, a fixed storage 23 such as a hard drive, flash storage, and the like, a removable media component 25 operative to control and receive an optical disk, flash drive, and the like, and a network interface 29 operable to communicate with one or more remote devices via a suitable network connection.

The bus 21 allows data communication between the central processor 24 and one or more memory components, which may include RAM, ROM, and other memory, as previously noted. Typically RAM is the main memory into which an operating system and application programs are loaded. A ROM or flash memory component can contain, among other code, the Basic Input-Output system (BIOS) which controls basic hardware operation such as the interaction with peripheral components. Applications resident with the computer 20 are generally stored on and accessed via a computer readable medium, such as a hard disk drive (e.g., fixed storage 23), an optical drive, floppy disk, or other storage medium.

The fixed storage 23 may be integral with the computer 20 or may be separate and accessed through other interfaces. The network interface 29 may provide a direct connection to a remote server via a wired or wireless connection. The network interface 29 may provide such connection using any suitable technique and protocol as will be readily understood by one of skill in the art, including digital cellular telephone, Wi-Fi, Bluetooth®, near-field, and the like. For example, the network interface 29 may allow the computer to communicate with other computers via one or more local, wide-area, or other communication networks, as described in further detail below.

Many other devices or components (not shown) may be connected in a similar manner (e.g., document scanners, digital cameras and so on). Conversely, all of the components shown in FIG. 1 need not be present to practice the present disclosure. The components can be interconnected in different ways from that shown. The operation of a computer such as that shown in FIG. 1 is readily known in the art and is not discussed in detail in this application. Code to implement the present disclosure, such as the media player, can be stored in computer-readable storage media such as one or more of the memory 27, fixed storage 23, removable media 25, or on a remote storage location.

FIG. 2 shows an example of a network configuration according to an implementation of the disclosed subject matter. One or more devices 10, 11, such as user devices, local computers, smart phones, tablet computing devices, and the like may connect to other devices via one or more networks 7. In some implementations, the computing device 20 of FIG. 1 may be one or more of the device 10, 11 shown in FIG. 2. Each device may be a computing device as previously described. The network may be a local network, wide-area network, the Internet, or any other suitable communication network or networks, and may be implemented on any suitable platform including wired and/or wireless networks. The devices may communicate with one or more remote devices, such as servers 13 and/or databases 15. The remote devices may be directly accessible by the devices 10, 11, or one or more other devices may provide intermediary access such as where a server 13 provides access to resources stored in a database 15. The devices 10, 11 also may access remote platforms 17 or services provided by remote platforms 17 such as cloud computing arrangements and services. The remote platform 17 may include one or more servers 13 and/or databases 15. In some implementations, the server 13 may be an application store server that is capable of performing any of the processes of FIGS. 1-5 described above. In some implementations, the server 13, the database 15, and/or the remote platform 17 may provide media content such as text, books, audio, video, movies, music playlist, music albums, photos, photo albums, or the like.

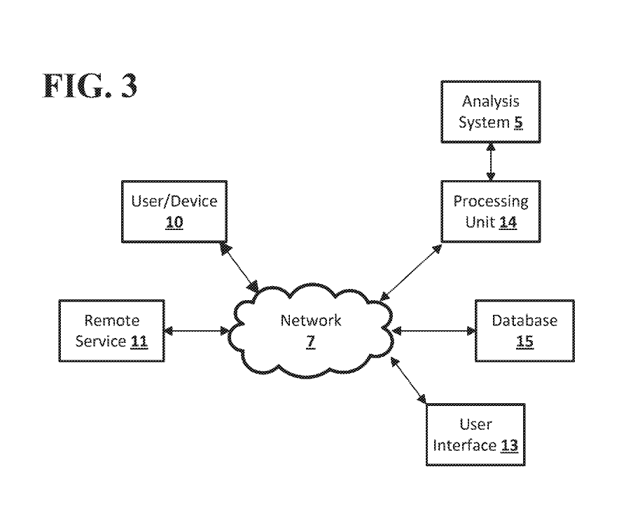

FIG. 3 shows an example of a system configuration according to an implementation of the disclosed subject matter. One or more devices or systems 10, 11, such as remote services or service providers 11, user devices 10 such as local computers, smart phones, tablet computing devices, and the like, may connect to other devices via one or more networks 7. The network may be a local network, wide-area network, the Internet, or any other suitable communication network or networks, and may be implemented on any suitable platform including wired and/or wireless networks. The devices 10, 11 may communicate with one or more remote computer systems, such as processing units 14, databases 15, and user interface systems 13. In some cases, the devices 10, 11 may communicate with a user-facing interface system 13, which may provide access to one or more other systems such as a database 15, a processing unit 14, or the like. For example, the user interface 13 may be a user-accessible web page that provides data from one or more other computer systems. The user interface 13 may provide different interfaces to different clients, such as where a human-readable web page is provided to a web browser client on a user device 10, and a computer-readable API or other interface is provided to a remote service client 11.

The user interface 13, database 15, and/or processing units 14 may be part of an integral system, or may include multiple computer systems communicating via a private network, the Internet, or any other suitable network. One or more processing units 14 may be, for example, part of a distributed system such as a cloud-based computing system, search engine, content delivery system, or the like, which may also include or communicate with a database 15 and/or user interface 13. In some arrangements, an analysis system 5 may provide back-end processing, such as where stored or acquired data is pre-processed by the analysis system 5 before delivery to the processing unit 14, database 15, and/or user interface 13. For example, a machine learning system 5 may provide various prediction models, data analysis, or the like to one or more other systems 13, 14, 15. In some implementations, any computing device associated with the network 7, such as the analysis system 5, the remote service client 11, or the processing unit 14, may perform any of the processes of FIGS. 1-5 described above.

More generally, various implementations of the presently disclosed subject matter may include or be embodied in the form of computer-implemented processes and apparatuses for practicing those processes. Implementations also may be embodied in the form of a computer program product having computer program code containing instructions embodied in non-transitory and/or tangible media, such as floppy diskettes, CD-ROMs, hard drives, USB (universal serial bus) drives, or any other machine readable storage medium, such that when the computer program code is loaded into and executed by a computer, the computer becomes an apparatus for practicing implementations of the disclosed subject matter. Implementations also may be embodied in the form of computer program code, for example, whether stored in a storage medium, loaded into and/or executed by a computer, or transmitted over some transmission medium, such as over electrical wiring or cabling, through fiber optics, or via electromagnetic radiation, such that when the computer program code is loaded into and executed by a computer, the computer becomes an apparatus for practicing implementations of the disclosed subject matter. When implemented on a general-purpose microprocessor, the computer program code segments configure the microprocessor to create specific logic circuits.

In some configurations, a set of computer-readable instructions stored on a computer-readable storage medium may be implemented by a general-purpose processor, which may transform the general-purpose processor or a device containing the general-purpose processor into a special-purpose device configured to implement or carry out the instructions. Implementations may be implemented using hardware that may include a processor, such as a general purpose microprocessor and/or an Application Specific Integrated Circuit (ASIC) that embodies all or part of the techniques according to implementations of the disclosed subject matter in hardware and/or firmware. The processor may be coupled to memory, such as RAM, ROM, flash memory, a hard disk or any other device capable of storing electronic information. The memory may store instructions adapted to be executed by the processor to perform the techniques according to implementations of the disclosed subject matter.

The foregoing description, for purpose of explanation, has been described with reference to specific implementations. However, the illustrative discussions above are not intended to be exhaustive or to limit implementations of the disclosed subject matter to the precise forms disclosed. Many modifications and variations are possible in view of the above teachings. The implementations were chosen and described in order to explain the principles of implementations of the disclosed subject matter and their practical applications, to thereby enable others skilled in the art to utilize those implementations as well as various implementations with various modifications as may be suited to the particular use contemplated.

1. A method comprising:
displaying, on a display coupled to an electronic device, mixed multimedia content in a scrollable container;
displaying, on the display coupled to the electronic device, thumbnails of playable media items in the mixed multimedia content;
visually replacing, on the display coupled to the electric device, at least one media item thumbnail of the thumbnails of playable media items with a media player user interface that plays back a media item of the playable media items based on detecting a user interaction, wherein the user interaction is determined by the electronic device as an intention to start consuming the media item;
repositioning, on the display coupled to the electronic device, the media player when a scrollable container is scrolled, in tandem with a scrolling motion, so the media player appears inlined with the mixed multimedia content; and
moving, on the display coupled to the electronic device, the media player to a designated position on the display to allow uninterrupted consumption of the mixed multimedia content, including the media to be played back, when the scrollable container is scrolled to an extent where it is determined, at the electronic device, that the position of the media player based on the scrolling interrupts the consumption of the mixed media content.

2. The method of claim 1, further comprising:
scrolling the scrollable container, on the display of the electronic device, in one direction that is selected from the group consisting of: a vertical direction, a horizontal direction, and a diagonal direction.

3. The method of claim 2, further comprising:
scrolling, on the display of the electronic device, additional containers in an orthogonal direction to the one direction.

4. The method of claim 1, further comprising:
scrolling the scrollable container omni-directionally on the display of the electronic device.

5. The method of 1, further comprising:
automatically scrolling, on the display coupled to the electronic device, at least one of the group consisting of the scrollable container and one or more additional containers, based on the electronic device responding to the detected user interaction to start consumption of the media item, to position the media item thumbnail of the media item to be played by the media player in a position on the display suitable for the consumption of the media item.

6. The method of 1, wherein the determining that the position of the media player based on the scrolling interrupts the consumption of the mixed multimedia content comprises:
determining, at the electronic device, a suitability for consumption of the media item based on whether the media item thumbnail of the media to be played in the media player is displayed fully on the display coupled to the electronic device, and is not obstructed by other user interface components displayed on the display or displayed partially due to the scrollable container or additional scrollable containers.

7. The method of 1, further comprising:
increasing, on the display of the electronic device, a displayed size of the media player in response to a user command to expand the media consumption environment on the display.

8. The method of 1, further comprising:
reducing, on the display of the electronic device, a displayed size of the media player in response to a user command to reduce the media consumption environment on the display.

9. The method of 1, further comprising:
moving, on the display of the electronic device, the media player to a designated portion of the display in response to a received user command.

10. The method of claim 1, wherein the playable media item includes at least one from the group consisting of: a song, music albums, music playlists, audio, videos, movies, photos, books, articles, and text.

11. A system comprising:
a display device;
an electronic device communicatively coupled to the display, to control the display device to:
display mixed multimedia content in a scrollable container, to control the display device to display thumbnails of playable media items in the mixed multimedia content;
visually replace of at least one media item thumbnail of the thumbnails of playable media items with a media player user interface that plays back a media item of the playable media items based on detecting a user interaction, wherein the user interaction is determined by the electronic device as an intention to start consuming the media item;
reposition the media player when a scrollable container is scrolled, in tandem with a scrolling motion, so the media player appears inlined with the mixed multimedia content; and
move the media player to a designated position on the display device to allow uninterrupted consumption of the mixed multimedia content, including the media to be played back, when the scrollable container is scrolled to an extent where it is determined, at the electronic device, that the position of the media player based on the scrolling interrupts the consumption of the mixed media content.

12. The system of claim 11, wherein the electronic device controls the scrolling of the scrollable container on the display device in one direction that is selected from the group consisting of: a vertical direction, a horizontal direction, and a diagonal direction.

13. The system of claim 12, wherein the electronic device controls the scrolling of additional containers, on the display device, in an orthogonal direction to the one direction.

14. The system of claim 11, wherein the electronic device controls the scrolling of the scrollable container omni-directionally on the display device.

15. The system of 11, wherein the electronic device controls an automatic scrolling of at least one of the group consisting of the scrollable container and one or more additional containers on the display device, based on the electronic device responding to the detected user interaction to start consumption of the media item, to position the media item thumbnail of the media item to be played by the media player in a position on the display suitable for the consumption of the media item.

16. The system of 11, wherein the electronic device determines that the position of the media player based on the scrolling interrupts the consumption of the mixed multimedia content based on a determination of a suitability for consumption of the media item based on whether the media item thumbnail of the media to be played in the media player is displayed fully on the display device, and is not obstructed by other user interface components displayed on the display device or displayed partially due to the scrollable container or additional scrollable containers.

17. The system of 11, wherein the electronic device controls an increase in a displayed size of the media player on the display device in response to a user command to expand the media consumption environment on the display.

18. The system of 11, wherein the electronic device reduces a displayed size of the media player on the display device in response to a user command to reduce the media consumption environment on the display.

19. The system of 11, wherein the electronic device moves the media player on the display device to a designated portion of the display device in response to a received user command.

20. The system of claim 11, wherein the playable media item includes at least one from the group consisting of: a song, music albums, music playlists, audio, videos, movies, photos, books, articles, and text.
